(19) United States
(12) Patent Application Publication
(10) Pub. No.: US 2018/0368623 A1
(43) Pub. Date: Dec. 27, 2018

(54) CONTAINER ASSEMBLY

(71) Applicant: Platinum Products, LLC, Missoula, MT (US)

(72) Inventor: Anthony Cerasani, Missoula, MT (US)

(21) Appl. No.: 16/062,553

(22) PCT Filed: Dec. 13, 2016
(86) PCT No.: PCT/US2016/066401

§ 371 Date: Jun. 14, 2018

Related U.S. Application Data
(60) Provisional application No. 62/267,109, filed on Dec. 14, 2015.
(60) Provisional application No. 62/354,555, filed on Jun. 24, 2016.

(51) Int. Cl. A47J 43/27; B65D 81/32; A45F 3/20; A47J 31/44; A47J 31/40; B65D 21/02

(52) U.S. Cl. CPC A47J 43/27; B65D 81/3205; B65D 21/0217; A47J 31/44; A47J 31/407; A45F 3/20

(57) ABSTRACT

An assembly of containers, hand-holdable containers, and shaker cups includes magnetic elements to couple one or more components of the assembly to one another, the assembly of containers including a first container having a first cup with a first magnet positioned in a closed bottom end thereof, and a second container having a lid with a second magnet, complementary to the first magnet, positioned in a top end thereof.

### BACKGROUND

### Technical Field

The present disclosure relates generally to hand-holdable containers and, more particularly, to a shaker cup with associated containers that include magnets to couple containers to each other and to the shaker cup in a nested relationship.

### Description of the Related Art

Hand-holdable containers with removable lids are a well-known means for manually mixing beverages. While mechanical devices such as electric blenders have been developed, they require a source of electric power and are not readily transportable.

Recent designs known as “shaker cups” have become popular due to their portability and ease of use. Shaker cups are used to mix and dispense a variety of liquefied foods and beverages. They typically include a means to hold the cup, such as a handle or hand grips, to enable a user to drink the beverage. One common use of a shaker cup is to mix a protein powder with water in the same container from which the user drinks the mixed protein powder and water. Shaker cups can be convenient for users who desire to mix and consume food or beverages while on the go.

A variety of shaker cups are commercially available. A simple shaker cup typically includes a cup and a lid. A user introduces the ingredients to be mixed into the cup, attaches the lid to the cup to seal the items inside the cup, and shakes the sealed cup to mix the ingredients together. Some shaker cups include a whisking or mixing element, which can be attached to the cup or the lid, or it can be an independent component that moves freely within the shaker cup as the cup is shaken.

### BRIEF SUMMARY

In accordance with the present disclosure, an assembly of containers is provided. The assembly includes a first container having a first cup with an interior space defined by at least one wall, a closed bottom end, and an open top. A first magnetic element is positioned in the closed bottom end of the cup. The assembly further includes a first lid structured to be removably coupled to the first cup and sized and shaped to cover the open top of the first cup, the lid including a spout, and a mixing element positioned within the interior space. A second container is also included that has a second cup with an interior space defined by at least one wall, a closed bottom end, and an open top, and a second lid configured to be removably coupled to the second cup and sized and shaped to cover the open top of the second cup. The second container also includes a second magnetic element complementary to the first magnetic element, the second magnetic element positioned in the second lid and structured to removably couple the second cup to the first cup by magnetic attraction when the second magnetic element is magnetically coupled to the first magnetic element.

In some implementations, the first lid includes a through opening structured to be in fluid communication with the interior space of the first cup when the first lid is placed on the first cup; a cap mounted on the lid and sized and shaped to move between a closed position in which the cap covers the through opening and prevents liquid from passing through the through opening, and an open position in which fluid is allowed to pass through the through opening; a third magnetic element mounted on the lid; and a fourth magnetic element mounted on the cap and structured to be magnetically attracted to the third magnetic element and hold the cap in the open position by magnetic attraction with the third magnetic element.

In some implementations, the first container is a hand-holdable shaker cup and the second container is hand-holdable.

### BRIEF DESCRIPTION OF THE SEVERAL VIEWS OF THE DRAWINGS

The foregoing features and advantages of the present disclosure will be more readily appreciated as the same become better understood from the following detailed description when taken in conjunction with the accompanying drawings, wherein:

FIG. 1 is an isometric view of an assembly of hand-holdable containers, according to at least one illustrated implementation;

FIG. 2 is an exploded view of the assembly of hand-holdable containers of FIG. 1;

FIG. 3 is a cross-sectional exploded view of the assembly of hand-holdable containers of FIG. 1;

FIG. 4 is a cross-sectional view of some components of the assembly of hand-holdable containers of FIG. 1;

FIG. 5 is an isometric view of an assembly of hand-holdable containers in accordance with another implementation of the present disclosure;

FIG. 6 is an exploded view of the assembly of hand-holdable containers of FIG. 5;

FIG. 7 is a cross-sectional exploded view of the assembly of hand-holdable containers of FIG. 5;

FIG. 8 is a top view of the assembly of hand-holdable containers of FIG. 5 with a cap in an open position and a latch in a closed position;

FIG. 9 is a top view of the assembly of hand-holdable containers of FIG. 5 with a cap in a closed position and a latch in an open position;

FIG. 10 is a cross-sectional view illustrating additional features of some of the components of the hand-holdable containers of FIG. 5;

FIG. 11 is an isometric view illustrating additional details of a lid of the assembly of hand-holdable containers of FIG. 1;

FIG. 12 is an exploded isometric view of an assembly of hand-holdable containers, according to at least one illustrated implementation;

FIG. 13 is a top isometric view of a lid of the assembly of FIG. 12;

FIG. 14 is a cross-sectional side view of the lid of FIG. 13;

FIG. 15 is a top isometric view of a cup of the assembly of FIG. 12;

FIG. 16 is a bottom isometric view of the cup of FIG. 15;

FIG. 17 is a bottom isometric view of a cover of the assembly of FIG. 12;

FIG. 18 is an exploded isometric view of an assembly of hand-holdable containers, according to at least one illustrated implementation; and

FIG. 19 is a bottom isometric view of a cup of the assembly of FIG. 18.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures or components or both associated with hand-holdable containers have not been shown or described, such as handles, sealing means for lids, and mixing elements, in order to avoid unnecessarily obscuring descriptions of the implementations.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation. Furthermore, the particular features, structures, or characteristics may be combined in any suitable manner in one or more implementations.

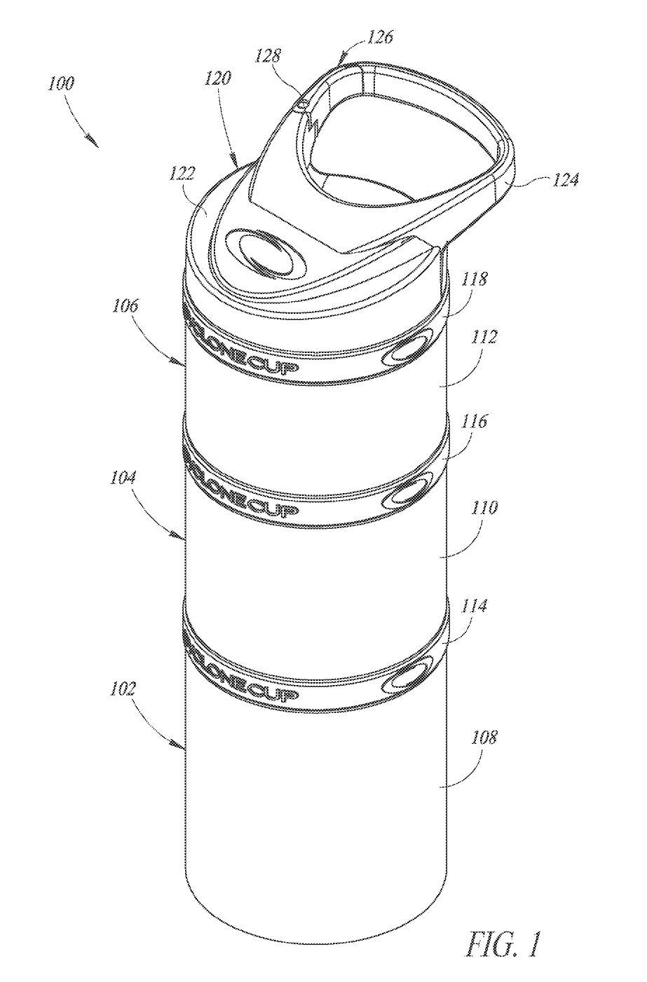

FIG. 1 illustrates an assembly 100 of hand-holdable containers in an assembled state. The assembly 100 includes a first container 102 having a first cup 108 removably coupled to a first lid 114, a second container 104 having a second cup 110 removably coupled to a second lid 116, a third container 106 having a third cup 112 removably coupled to a third lid 118, and a cover 120 removably coupled to the third container 106. As described further below, each of the cups 108, 110, and 112 has an open internal space that can be used to store a first item, such as a first ingredient. As also described further below, each of the lids 114, 116, and 118 is itself a container having an enclosed internal space separated and distinct from the internal space of the respective cup, which can be used to store a second item different from the first item, such as a second ingredient. Thus, the assembly 100 of hand-holdable containers can be referred to as an assembly 100 of nested containers, because it includes a plurality of containers in a nested arrangement.

The first container 102 can be removably coupled to the second container 104, and the second container 104 can be removably coupled to the third container 106. For example, a top end of the first lid 114 can be removably coupled to a bottom end of the second cup 110, and a top end of the second lid 116 can be removably coupled to a bottom end of the third cup 112. Thus, the assembly 100 of hand-holdable containers can be referred to as an assembly 100 of stacked containers, because it includes a plurality of containers in a stacked arrangement.

The terms up, down, above, below, top, and bottom are used herein to refer to the relative positions of various components. As used herein, these terms generally carry their ordinary meaning, such that the lids described herein are designed to be positioned above or on top of the respective cups. Thus, the first container 102, first cup 108, and first lid 114 are referred to as a bottom container 102, bottom cup 108, and bottom lid 114, the second container 104, second cup 110, and second lid 116 are referred to as an intermediate container 104, intermediate cup 110, and intermediate lid 116, and the third container 106, third cup 112, and third lid 118 are referred to as a top container 106, top cup 112, and top lid 118.

As illustrated in FIG. 1, the bottom cup 102 is taller and larger than the intermediate cup 104, and the intermediate cup 104 is taller and larger than the top cup 106. The bottom lid 114, intermediate lid 116, and top lid 118 have the same size and the same configurations, and are identical to one another, such that they are interchangeable and any one of the lids 114, 116, and 118, can be used with any one of the cups 108, 110, and 112. The different sizes of the cups 108, 110, and 112 allow a user to select a particular one of the cups 108, 110, and 112 based on the particular ingredient and amount of the particular ingredient to be stored therein. It is to be understood that the cups may be of the same size. It is to be further understood that the order of stacking or nesting of the different sized containers or cups may be other than as disclosed herein. It is also to be understood that the cover 120 can be magnetically and removably coupled to any one of the lids 114, 116, and 118, and thereby to any one of the containers 102, 104, and 106.

Still referring to FIG. 1, each of the containers 102, 104, and 106, including their respective cups and lids, have outer peripheral surfaces having circular cross-sectional shapes, such that each is substantially cylindrical along a central longitudinal axis extending from the top to the bottom of the assembly 100. In other implementations, the containers 102, 104, and 106 have outer peripheral surfaces having other shapes, such as oval, elliptical, triangular, or square shapes, all of which are a matter of design choice and do not affect the function of the containers individually or the assembly as a whole. Further, each of the containers 102, 104, and 106, including their respective cups and lids, have the same or substantially the same diameter along the entire longitudinal axis, such that the containers 102, 104, and 106 form a single cylindrical body or column of uniform diameter when stacked together on top of one another. The lids 114, 116, and 118 have outer diameters that are slightly larger than outer diameters of the respective cups 108, 110, and 112, such that the peripheral edges of the lids 114, 116, and 118 form annular ridges or protrusions extending radially beyond the peripheral edges of the cups 108, 110, and 112, in order to facilitate a user gripping the lids 114, 116, and 118 and manually separating the containers 102, 104, and 106 from one another.

The cups 108, 110, and 112, and the lids 114, 116, and 118, are opaque or substantially opaque, such that the contents of the containers 102, 104, and 106 are not visible. In other implementations, the cups 108, 110, 112, or the lids 114, 116, 118, or both, are translucent or substantially translucent, such that an amount of the contents or a level to which the contents fill the respective containers can be seen by a user. In other implementations, the cups 108, 110, 112, and/or the lids 114, 116, 118, are transparent or substantially transparent, such that the contents of the respective containers can be seen by a user.

The cover 120 includes a base 122 and a handle 124 extending upwardly and laterally away from the base 122. The base 122 of the cover 120 is removably coupled to the top lid 118 of the top container 106. The base 122 has an outer peripheral surface having a shape that matches that of the containers 102, 104, and 106, i.e., a circular shape having a diameter matching that of the containers 102, 104, and 106. Thus, the base 122 is substantially cylindrical along the central longitudinal axis of the assembly 100, and forms a top end portion of the single cylindrical body or column of the assembly 100.

The handle 124 includes a rigid loop of material that extends upwardly and laterally away from the base 122, and that can be grasped by a user to hold the assembly 100. The handle 124 includes a spring-loaded latch 126 that can be pushed or otherwise actuated by a user to pivot about a hinge 128 to open the loop of material of the handle 124. In one implementation, the latch 126 can be pushed inward toward the center of the loop of material to open the loop, while in another implementation, the latch 126 can be pushed outward away from the center of the loop of material to open the loop. In either case, the latch is spring-loaded to cause the latch to close once the user stops pushing on it. A user can create an opening in the loop of material by actuating the latch 126, and use the opening to couple the assembly 100 to other items, such as a belt, strap, rope, or other item. Preferably, the latch 126 conforms to the shape of the handle 124 to present a smooth surface with all facets of the handle 124. The handle 124 can assume many shapes while retaining its function. Hence, the shape and contours of the handle are a matter of design choice. In some implementations, the handle 124 does not include the latch 126.

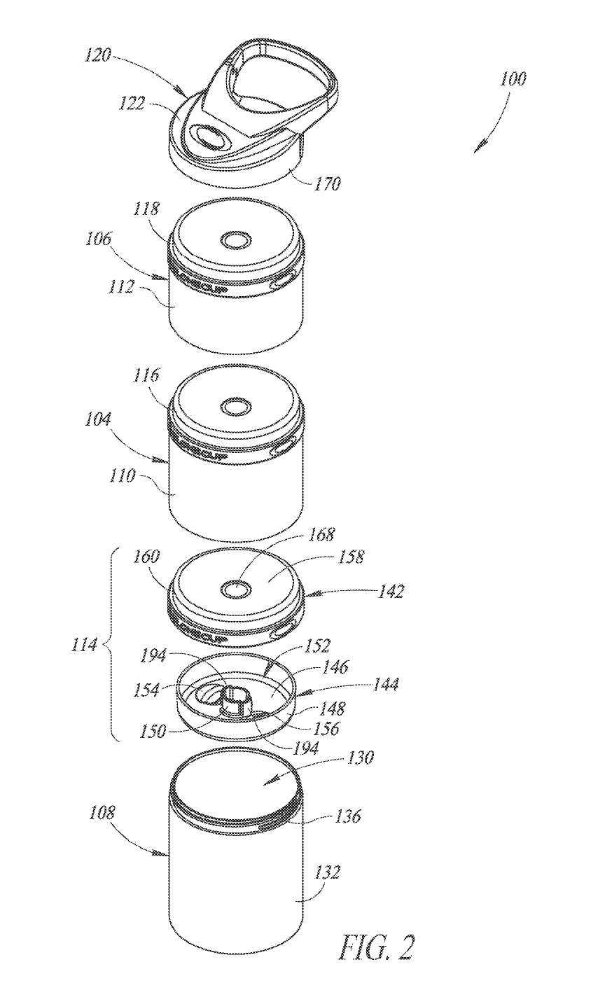

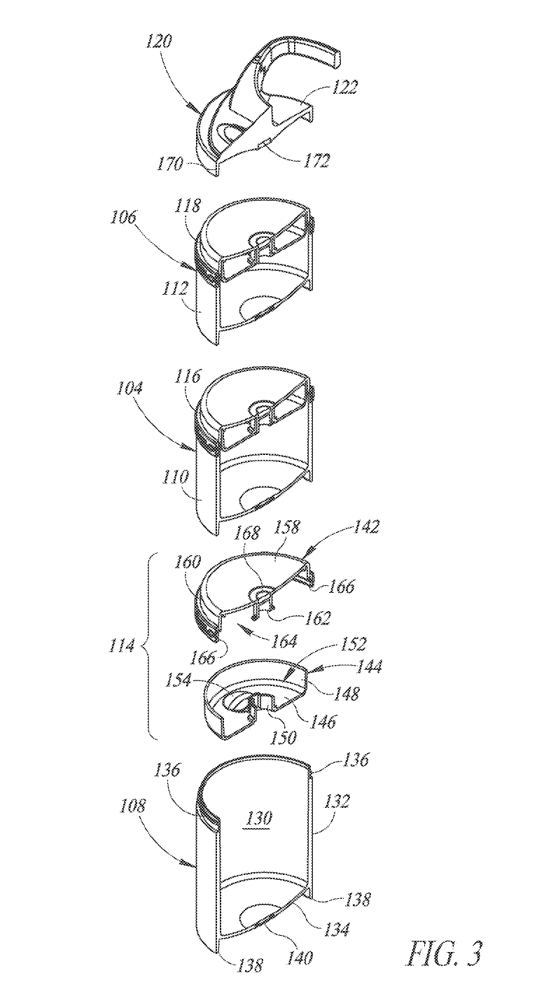

FIGS. 2 and 3 show the assembly 100 in a partially disassembled state and a cross-sectional view of that partially disassembled state, respectively. The bottom cup 108 includes an open interior space 130 defined by an outer peripheral wall 132, a closed bottom or wall 134, and an open top end. An outer annular surface of the top end of the peripheral wall 132 includes threads 136 extending circumferentially around the exterior of the peripheral wall 132. A bottom end of the peripheral wall 132 extends longitudinally beyond the bottom wall 134 of the cup 108, such that the bottom end of the peripheral wall 132 forms an annular flange 138 extending away from the bottom of the cup 108. A cup magnet 140 having a first polarity is coupled to the bottom end of the cup 108, such as in a bottom surface of and at the center of the bottom wall 134 of the cup 108. The intermediate cup 110 and the top cup 112 have structures similar to or matching the structure of the bottom cup 108, except that they have smaller heights.

As described above, the bottom lid 114 is itself a container. The bottom lid 114 is sized and shaped to cover the open top end of the bottom cup 108. The bottom lid 114 includes a top casing 142 and a bottom casing 144 that are removably coupleable to one another to form an enclosed container. The bottom casing 144 includes a closed bottom end or wall 146, a cylindrical outer peripheral wall 148, a hollow cylindrical inner wall 150, and an annular internal storage space 152 defined between the outer wall 148 and the inner wall 150 for storing items within the bottom lid 114. The bottom casing 144 also includes a pair of finger grips 154, 156 formed in the bottom wall 146, which allow a user to more easily grasp and manipulate the bottom casing 144 when the bottom casing 144 is engaged with the top casing 146, such as to facilitate the user pulling the top and bottom casings 142, 144, apart from one another. The finger grips 154, 156 are spaced apart from one another by 180° about the central longitudinal axis of the bottom lid 114, that is, across the inner wall 150 from one another. The particular contours of the finger grips 154, 156 may assume a variety of shapes that are merely aesthetic and have no particular function other than to present an appealing appearance alone and in conjunction with the overall shape and contours of the assembly 100.

The top casing 142 includes a closed top end or wall 158, a cylindrical outer peripheral wall 160, a hollow cylindrical inner wall 162, and an annular internal storage space 164 defined between the outer wall 160 and the inner wall 162 for storing items within the bottom lid 114. An inner surface of a bottom end of the outer wall 160 includes threads 166 that are complementary to the threads 136 of the bottom cup 108, to allow the bottom lid 114 to be threadedly coupled to or screwed on the top end of the bottom cup 108. A lid magnet 168 having a second polarity is coupled to the top end of the lid 114, such as in a top surface of and at the center of the top wall 158 of the top casing 142. The second polarity of the lid magnet 168 is complementary to the first polarity of the cup magnet 140. The intermediate lid 116 and the top lid 118 have structures matching or identical to the structure of the bottom lid 114, such that the lids 114, 116, and 118 are interchangeable with one another.

As described above, the cover 120 includes a base 122 that is removably coupled to the top lid 118. The base 122 includes a cylindrical outer peripheral wall 170 and a cover magnet 172 having a third polarity matching the first polarity of the cup magnet 140. The cover magnet 172 is coupled to a bottom surface of the base 122 of the cover 120, such as at a center of the bottom surface of the base 122.

To use the assembly 100, a user can insert a first ingredient into the first cup 108, a second ingredient into the second cup 110, a third ingredient into the third cup 112, a fourth ingredient into the bottom casing of the first lid 114, a fifth ingredient into the bottom casing of the second lid 116, and a sixth ingredient into the bottom casing of the third lid 118. The ingredients can be the same as one another or each can be different from the other. The user can then couple the top and bottom casings of each of the lids 114, 116, and 118 to one another to enclose the fourth, fifth, and sixth ingredients. The user can then removably couple (e.g., screw on) the lids 114, 116, and 118 to the top ends of the cups 108, 110, and 112, such as by engaging the threads 136 with the complementary threads 166, to form the containers 102, 104, and 106 and enclose the first, second, and third ingredients. The containers 102, 104, and 106, and the cover 120 can then be removably coupled to one another, such as by engaging the various lid magnets having the second polarity with the cup and cover magnets having the first polarity complementary to the second polarity.

The user can then carry the assembly 100 from place to place while on the go, to take the various ingredients with them over the course of their day. The user can carry the assembly by holding the main body of the assembly 100, such as by grasping any one or any combination of the containers 102, 104, and 106, in their hand, or by holding the handle 124. When the user desires to consume one or more of the ingredients, the user can de-couple the containers 102, 104, and 106 and the cover 120 from one another by pulling the respective magnets apart, such as by bending the assembly with respect to its central longitudinal axis. The user can then open any of the containers 102, 104, and 106 by unscrewing the respective lid from the respective cup, and can open any of the lids 114, 116, and 118 by using the finger grips 154, 156 to pull the respective top and bottom casings 142, 144 from one another.

The magnets used to retain the containers 102, 104, and 106 in a nested or stacked relationship are formed to have sufficient strength to hold the containers together when they are filled with material. Ideally, the magnets will hold the containers together when the assembly 100 is shaken during a manual mixing operation. The assemblies of containers described herein include pairs of magnets having complementary (e.g., opposite) polarities to magnetically couple components of the assemblies to one another. In some implementations, these magnets are standard neodymium iron boron magnets, grade N52 with commercial nickel-copper-nickel plating, magnetized through its thickness. In some implementations, different arrangements are used to magnetically couple the various components to one another. For example, in some implementations, one of the magnets in a pair of complementary magnets is replaced with a ferrous metal or with stainless steel, 430 series, standard 2BA finish or better on both sides. In one specific implementation, the lid magnets 168 are neodymium magnets and the cup magnets 140 are stainless steel. In some implementations, the magnets are not included.

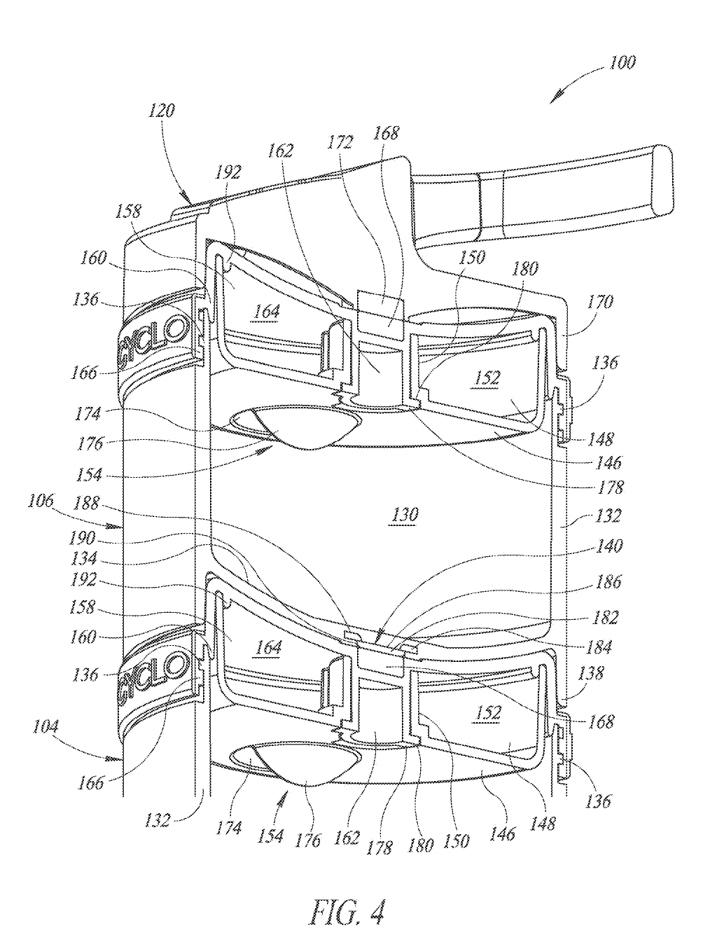

FIG. 4 illustrates, in greater detail, features of the assembly 100 that allow the various components of the assembly 100 to be removably coupled to and decoupled from one another. Reference numerals used in FIGS. 2 and 3 to indicate features of the bottom container 102 are used in FIG. 4 to indicate similar matching features of the intermediate container 104 and the top container 106.

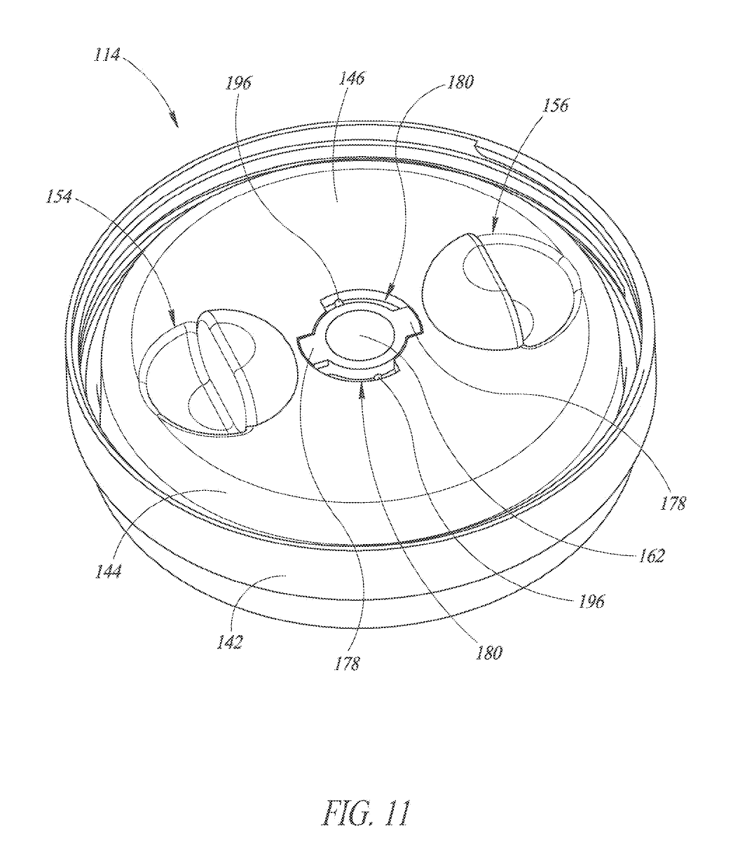

As illustrated in FIG. 2, the inner wall 150 of the bottom casing 144 includes a pair of opposed recesses 194 that extend radially outwardly from a center of the inner wall 150 and extend longitudinally along the length of the inner wall 150. As illustrated in FIGS. 4 and 11, the cylindrical inner wall 162 of the top casing 142 includes a pair of opposed, outer peripheral ridges 178 extending radially outward from, and partially circumferentially around, a bottom end thereof, and the bottom casing 144 includes a corresponding pair of grooves 180, each extending partially circumferentially around a bottom end of the cylindrical inner wall 150 where the inner wall 150 meets the bottom wall 146. The grooves 180 are positioned in an inner surface and at a bottom end of the inner wall 150 and in a bottom surface and at an inner end of the bottom wall 146, and are complementary to the pair of ridges 178. An outer diameter of the inner wall 162 is complementary or equal to an inner diameter of the inner wall 150, such that the inner wall 162 can be pushed through and positioned within the hollow inner wall 150.

To couple the top casing 142 to the bottom casing 144, a user can push the inner wall 162 through the inner wall 150, such as by sliding the ridges 178 through the recesses 194, until the ridges 178 are seated within the grooves 180. The user can then rotate the top casing 142 with respect to the bottom casing 144 to move the ridges 178 away from the recesses 194 through the grooves 180, such as until the ridges 178 are locked in place by being brought into contact with respective detents 196 formed within the grooves 180. A distance between the radially-outermost ends of the ridges 178 is larger than an inner diameter of the hollow inner wall 150 to prevent the top casing 142 from inadvertently separating from the bottom casing 144.

As also illustrated in FIG. 4, the finger grip 154 includes two adjacent and opposed semi-hemispherical deformations in the bottom wall 146 of the bottom casing 144. A first one of these deformations is a raised protrusion 174 extending upwardly from the bottom wall 146, and a second one of these deformations is a depression 176 extending downwardly from the bottom wall 146. The protrusion 174 is located radially outward of the depression 176 with respect to a central longitudinal axis of the assembly 100. The protrusion 174 and the depression 176 are adjacent to one another and opposed to one another across a plane parallel to the plane of the cross section of FIG. 4.

The protrusion 174 has a vertical and semi-circular face extending upward from the bottom wall 146, and the depression 176 has a vertical and semi-circular face extending downward from the bottom wall 146, along the plane across which the protrusion 174 and depression 176 are opposed. These vertical and semi-circular faces of the protrusion 174 and the depression 176 together form a single vertical wall that has a circular shape. In other implementations, this single vertical wall has other shapes, such as oval, elliptical, or other suitable shapes, all of which are dictated by design considerations of aesthetics and visual appeal that do not affect the function. In other words, the depths, contours, and overall shapes of the finger grips can be configured to use any number configurations without impacting performance and function.

The finger grip 156, which is not illustrated in the cross-sectional view of FIG. 4, has the same construction as the finger grip 154 and is a mirror image of the finger grip 154 across the plane of the cross section of FIG. 4. Thus, together, the finger grips 154 and 156 provide a pair of vertical walls parallel to one another and opposed to one another across the center of the assembly 100, such that they face in opposing directions. This allows a user to grasp the top casing 142 with a first hand and grasp the bottom casing 144 by the finger grips 154, 156 with two fingers of a second hand, squeeze the finger grips 154, 156 toward one another, and pull the top casing 142 apart from the bottom casing 144.

FIG. 4 also illustrates the cup magnets 140 having a main body 182 with a disk or cylindrical shape and a peripheral anchor 184 having a toroidal shape extending upwardly and laterally away from, and circumferentially around the main body 182. The bottom wall 134 of the cup 112 of the top container 106 includes a magnet recess 186 formed in a bottom surface thereof, into which the cup magnet 140 is seated so that it is flush with the bottom surface of the surrounding portions of the bottom wall 134. The recess 186 includes an annular space 188 that extends upwards and outwards from a face 190 of the recess, into which the anchor 184 of the magnet 140 is seated so that the magnet 140 is retained within the recess 186 and does not fall out of the recess 186. Adhesive may be used to retain the magnet 140 within the recess 186.

FIG. 4 also illustrates additional details of the outer peripheral wall 160. For example, the outer peripheral wall 160 of the top casing 142 has an inner diameter complementary to an outer diameter of the outer peripheral wall 148 of the bottom casing 144 so that the wall 160 fits snugly over the wall 148 to enclose contents within the lid. The upper casing 142 also includes a ridge 192 that protrudes downward from a bottom surface of the top wall 158. The ridge 192 extends circumferentially around the top wall 158 and is spaced apart from the outer wall 160 by a distance equal to, approximating, or complementary to the thickness of the outer wall 148, such that the top of the outer wall 148 of the bottom casing 144 can be snugly retained between the outer wall 160 and the circumferential ridge 192 of the top casing 142.

The threads 166 of the top casing 142 are positioned on an interior surface of a bottom portion of the outer wall 160, which is radially offset outwards with respect to a top portion of the outer wall 160 designed to mate with the outer wall 148 of the bottom casing 144, such that a space exists between the threads 166 and the outer wall 148 when the top and bottom casings 142, 144 are coupled to one another. The top end of a respective cup, an outer surface of which includes the threads 136, occupies this space when the cup is removably coupled to, threadedly engaged with, or screwed into, the lid. The annular flange 138 of each of the cups 108, 110, and 112 has a construction matching that of the peripheral wall 170 of the cover 120. The annular flange 138 and the peripheral wall 170 have inner diameters sized to allow them to snugly fit over the top portion of the outer wall 160 of the top casing 142.

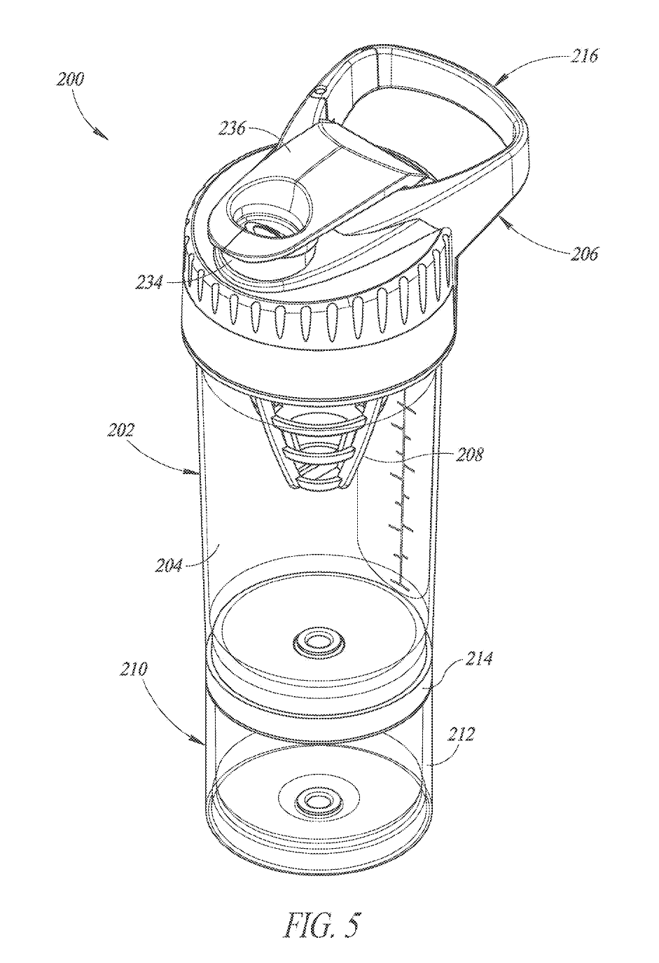

FIG. 5 illustrates an assembly 200 of hand-holdable containers in an assembled state. The assembly 200 includes a top container 202, which is a mixing cup 202, having a top cup 204 removably coupled to a top lid 206 and a mixing element 208, and a bottom container 210 having a bottom cup 212 removably coupled to a bottom lid 214. The assembly 200 of hand-holdable containers has substantial similarities to, as well as substantial differences from, the assembly 100 of hand-holdable containers. Unless stated otherwise herein, or unless physically impossible, the assembly 200 and its respective components will have any of the features described herein for the assembly 100 and its respective components, and the assembly 100 and its components will have any of the features described herein for the assembly 200 and its components.

For example, the assembly 200 of hand-holdable containers is referred to as an assembly 200 of nested containers, because it includes a plurality of containers in a nested arrangement, and can be referred to as an assembly 200 of stacked containers, because it includes a plurality of containers in a stacked arrangement. As another example, as shown in FIG. 5, the top cup 204 and the bottom cup 212 are transparent or substantially transparent, but in alternative implementations, these components can be translucent or substantially translucent or opaque or substantially opaque. As a further example, the bottom container 210 can have a construction and features matching those of one of the first, second, and third containers 102, 104, and 106. In addition, a bottom portion of the top cup 204 can have a construction and features matching those of a bottom portion of one of the cups 108, 110, and 112, and a handle 216 of the top lid 206 can have a construction and features matching those of the handle 124.

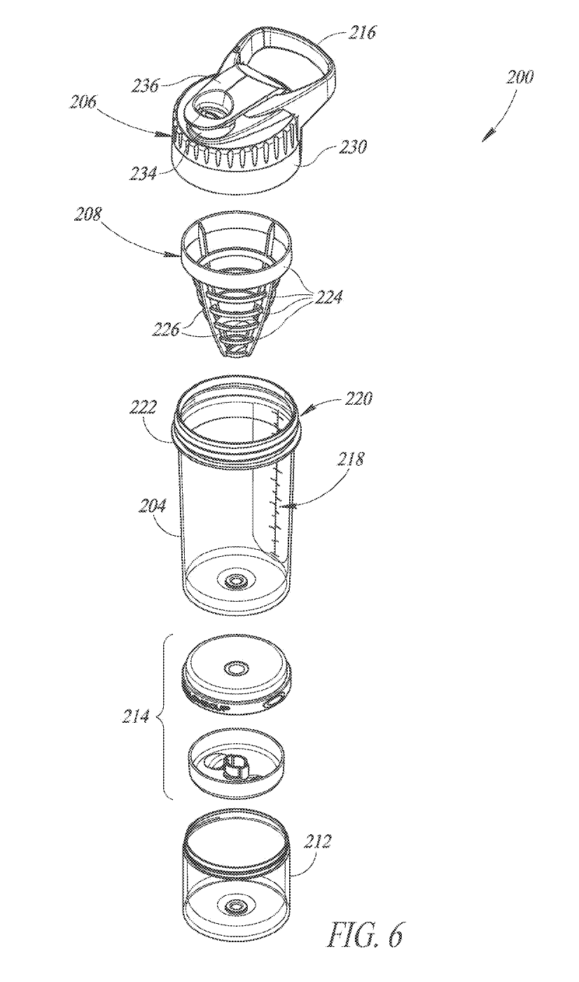

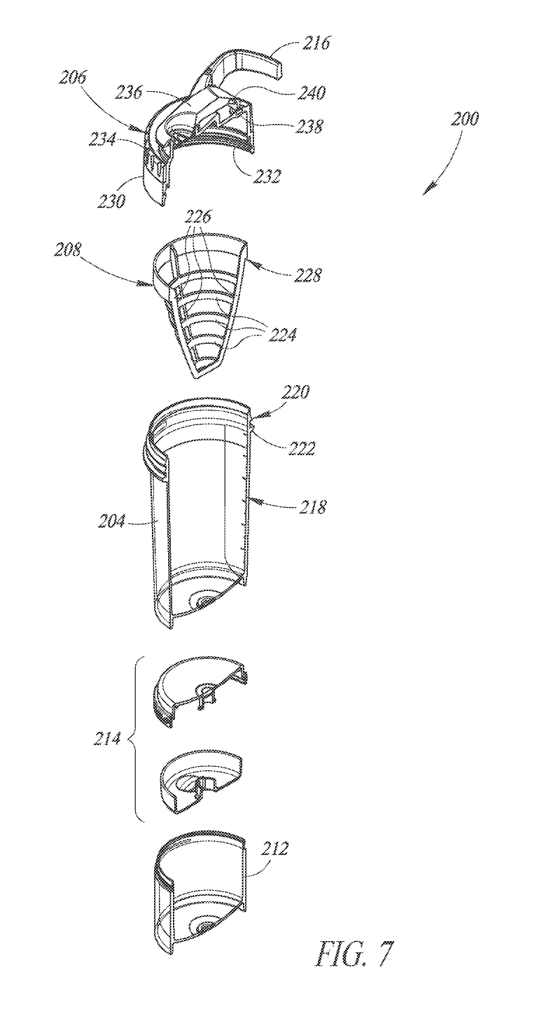

FIGS. 6 and 7 illustrate the assembly 200 in a partially disassembled state, and in a cross-sectional view of that partially disassembled state, respectively. The bottom container 210 and the bottom of the top cup 204 have constructions matching those of one of the containers 102, 104, and 106, and the bottom of the cups 108, 110, and 112, respectively and, thus, a description of their features would be redundant and is not repeated here. The top cup 204 is larger (e.g., taller) than the cups 108, 110, and 112, and the top container 202 is designed to be used as a shaker cup, in which various ingredients including solid and liquid ingredients can be mixed by a user. The top cup 204 includes a scale 218 printed on an outside thereof to assist a user in determining a quantity of the contents within the top cup 204.

An outer surface of a top end of the top cup 204 includes threads 220 that extend circumferentially around the top end of the top cup 204. The top cup 204 also includes a radially extending lip or ridge 222 that extends circumferentially around the top cup 204 just below and adjacent to the threads 220. The top lid 206 includes a base 230 and the handle 216 extending upward and outwardly from the base 230. An inner surface of the bottom end of the base 230 includes threads 232 complementary to the threads 220 at the top of the top cup 204. The top lid 206 is removably coupled to the top cup 204 by engaging the threads 232 with the threads 220 and twisting the top lid 206 onto the top cup 204 until a bottom rim of the top lid 206 contacts or abuts the lip 228 of the top cup 204. The mixing element 208 includes a plurality of circular members 224 and a plurality of ribs 226 coupled together to form a network of struts in a conical shape that tapers from a relatively wide top end to a relatively narrow bottom end. As illustrated in FIG. 7, the top-most circular member 224 extends radially outward from the rest of the mixing element 208 to form a lip 228 that is supported by a complementary feature formed at the top end of the top cup 204 so that the rest of the mixing element 208 hangs down into the top cup 204. For example, the lip 228 will rest on top of the rim of the top cup 204, or the lip 228 will rest on a circumferential ridge formed on an inner surface of the top cup 204, or a mouth or an open top end of the top cup 204 can be tapered such that an inner diameter of the mouth of the top cup 204 decreases moving into the top cup 204, and the lip 228 will rest on the tapered inner surface.

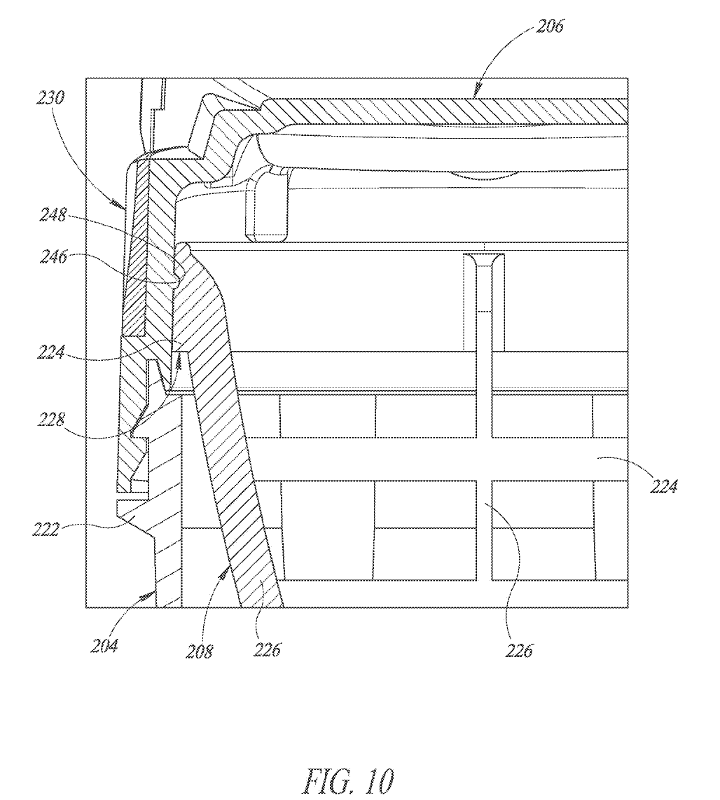

In such implementations, when the top lid 206 is removed from the top cup 204, the mixing element 208 remains on the top cup 204. In one alternative implementation, as illustrated in FIG. 10, the top lid 206 includes an annular ridge 246 extending circumferentially around, or a plurality of (e.g., six) tabs or ridges 246 each extending partially around, an inner surface of the top lid 206. The top-most circular member 224 of the mixing element 208 includes a corresponding groove 248 extending circumferentially around an outer surface thereof. The ridge 246 can be mated with the groove 248 to lock the mixing element 208 to the top lid 206. In such an implementation, when the top lid 206 is removed from the top cup 204, the mixing element 208 remains secured to the top lid 206.

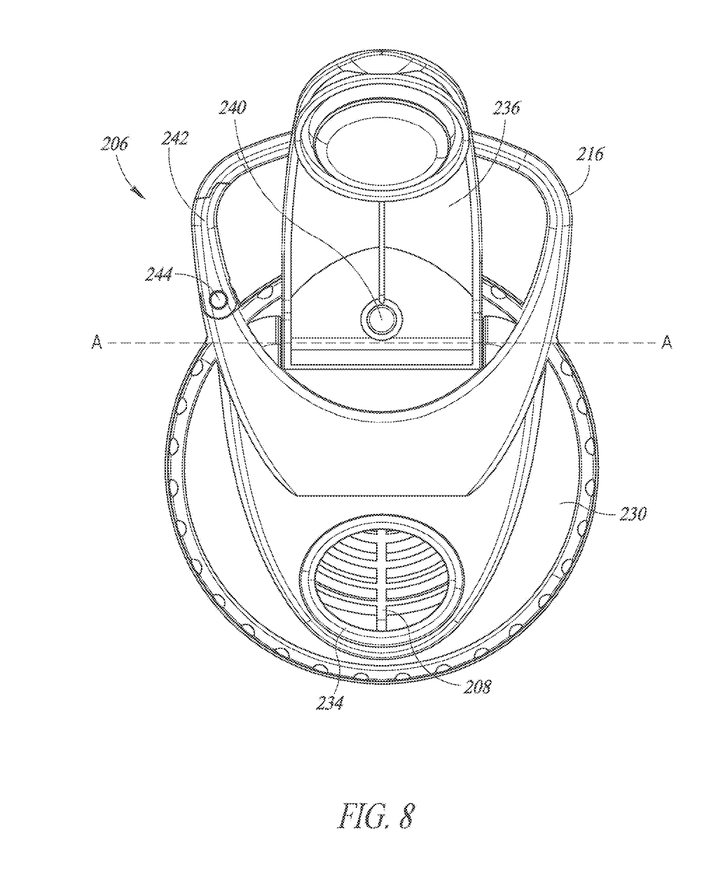

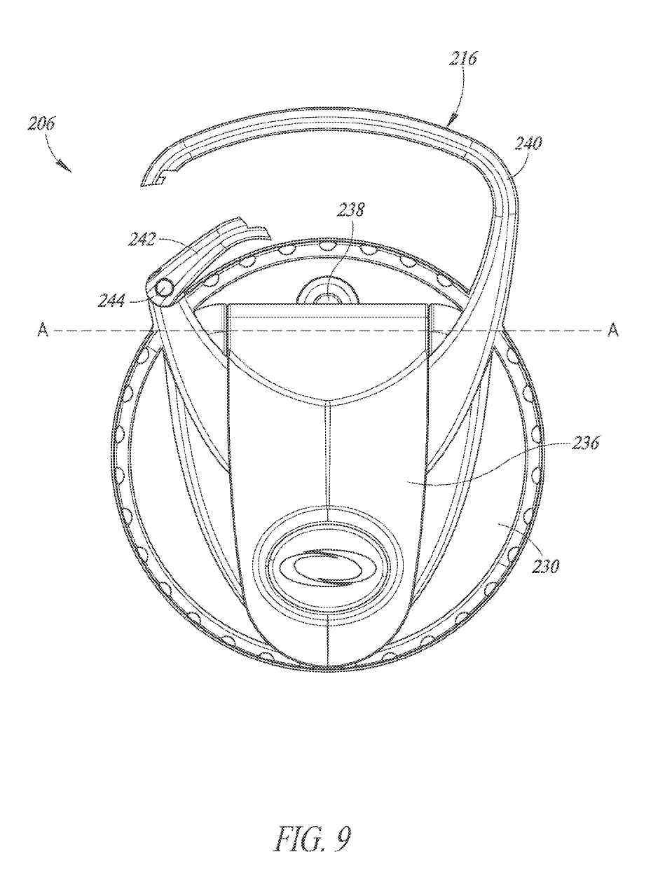

The top lid 206 includes a spout 234, which is a through opening structured to be in fluid communication with the interior space of the top cup 204, and a cap 236 to close and seal the spout 234. FIG. 8 illustrates the cap 236 in an open position, in which the cap 236 does not close, cover, or seal the spout 234, and the contents of the top cup 204, such as a fluid, can pass through the spout 234. FIG. 9 illustrates the cap 236 in a closed position, in which the cap 236 does close, cover, and seal the spout 234, and the cap 236 prevents the contents of the top cup 204, such as a liquid, from passing through the spout 234. As illustrated in FIGS. 8 and 9, the cap 236 is mounted to the base 230 of the top lid 206 on a hinge such that it is rotatable about an axis A-A. The cap rotates about the axis A-A to move from the open position to the closed position and from the closed position to the open position.

As illustrated in FIG. 8, a cap magnet 240 (also shown in cross section in FIG. 7) having a first polarity (independent of the polarities described with respect to the assembly 100) is mounted to a bottom surface of the cap 236 adjacent to the axis of rotation A-A. As illustrated in FIG. 9, a lid magnet 238 (also shown in cross-section in FIG. 7) having a second polarity complementary to the first polarity (independent of the polarities described with respect to the assembly 100) is mounted to a top surface of the base 230 of the lid 206, adjacent to the axis of rotation A-A. When the cap 236 is moved to the open position, the cap magnet 240 is adjacent to the lid magnet 238, and is separated from the lid magnet 238 by a thin portion of the cap 236 above the cap magnet 240. When the cap 236 is moved to the open position, a magnetic attraction between the lid magnet 238 and the cap magnet 240 restricts movement of the cap 236 and retains the cap 236 in the open position.

The handle 216 can have a construction and features matching those of the handle 124. For example, the handle 216 includes a rigid loop of material that extends upwardly and laterally away from the base 230 and a spring-loaded latch 242 rotatable about a hinge 244 between an open and a closed position, shown in FIGS. 9 and 8, respectively. In some implementations, the handle 216 does not include the latch 242. The handle 216 is mounted to the base 230 at a location between the spout 234 and the axis of rotation A-A of the cap 236. Thus, as the cap 236 rotates between the open and closed positions, as shown in FIGS. 8 and 9, respectively, it travels through the rigid loop of material of the handle 216.

To use the assembly 200, a user inserts a first ingredient into the bottom cup 212, a second ingredient into the bottom lid 214, and a third ingredient into the top cup 204. The user assembles the bottom container 210 as described for the containers 102, 104, and 106 above. The user then mounts the mixing element 208 within the cup 204 and screws the top lid 206 onto the top cup 204. The user then magnetically couples the top container 202 to the bottom container 210 in accordance with the description above to magnetically couple the containers 102, 104, and 106 to one another.

Once the user is ready to consume the ingredients, the user removes the top lid 206 from the top cup 204, opens the bottom container 210 and the bottom lid 214 as described above with respect to the containers 102, 104, and 106, and adds the ingredients stored therein to the ingredients stored in the top cup 204. The user will then screw the top lid 206 back on to the top cup 204, move the cap 236 to the closed position to seal the spout 234, and then shake the top container 202 to mix the ingredients. Once the ingredients are blended or mixed as desired, the user opens the cap 236 so that the cap magnet 240 is magnetically engaged with the lid magnet 238, and then consumes the mixed ingredients from within the top cup 204 through the spout 234.

In some implementations, the top container 202 is a stand-alone product. In some implementations, the assembly 100 is used as an independent kit of containers. In other implementations, the assembly 200 is used as an independent kit of containers or the assembly 100 and the assembly 200 are used together as an independent kit of containers, e.g., so that a user can select an appropriately sized container to couple to the bottom of the shaker cup 202 from a plurality of differently sized containers. It is to be understood that any combination of the various containers or components described herein can be used together as an independent kit of containers.

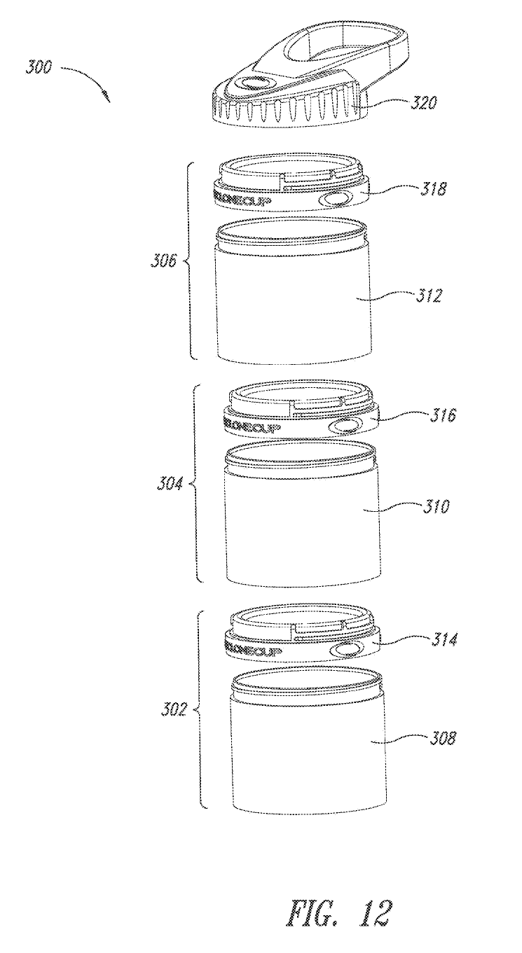

FIG. 12 illustrates an assembly 300 of hand-holdable containers in a disassembled state. The assembly 300 includes a first container 302 having a first cup 308 removably coupleable to a first lid 314, a second container 304 having a second cup 310 removably coupleable to a second lid 316, a third container 306 having a third cup 312 removably coupleable to a third lid 318, and a cover 320 removably coupleable to the third container 306. Each of the cups 308, 310, and 312 has an open internal space that is used to store a first item, such as a first ingredient. As also described further below, each of the lids 314, 316, and 318 has an open internal space that is separated and distinct from the internal space of the respective cup, which is used to store a second item different from the first item, such as a second ingredient.

The assembly 300 of hand-holdable containers has substantial similarities to, as well as substantial differences from, the assembly 100 of hand-holdable containers. Unless stated otherwise herein, or unless physically impossible, the assembly 300 and its respective components will have any of the features described herein for the assembly 100 and its respective components, and the assembly 100 and its components will have any of the features described herein for the assembly 300 and its components.

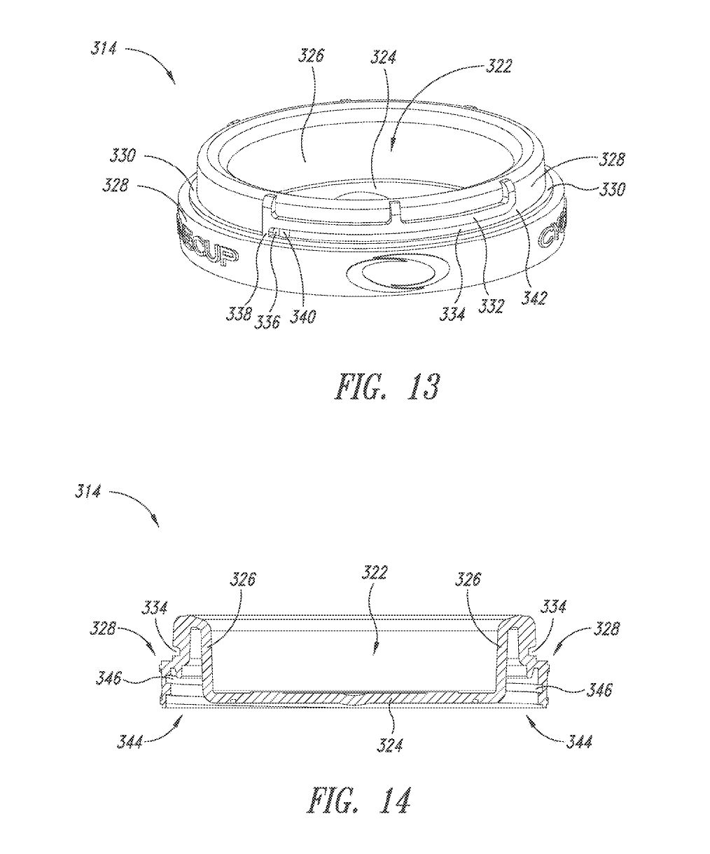

FIGS. 13 and 14 illustrate additional details of the first lid 314, which has a structure matching that of the second lid 316 and the third lid 318. As shown in FIG. 13, the first lid 314 includes an open internal space 322 bounded at its bottom by a bottom end wall 324 and at its perimeter by an inner circumferential wall 326. The inner circumferential wall 326 is coupled at its top end to a corresponding top end of an outer circumferential wall 328. A first circumferential ridge 330 extends radially outward from and completely around an outer surface of the outer circumferential wall 328. A second circumferential ridge 332 extends radially outward from and partially around the outer surface of the outer circumferential wall 328, and is parallel to and spaced apart from the first circumferential ridge 330 so that a groove 334 is defined between the first and second ridges 330, 332. A first end 336 of the groove 334 is closed by a vertical ridge 338 extending between and coupling the first circumferential ridge 330 to the second circumferential ridge 332. A raised bump or detent 340, having a height extending away from the outer circumferential wall 328 that is less than the heights of the ridges 330, 332, and 338 is positioned near the first end 336 of the groove 334 and is spaced apart from the vertical ridge 338. A second end 342 of the groove 334 is open.

As shown in FIG. 14, a gap or annular space 344 exists between the inner circumferential wall 326 and the outer circumferential wall 328, into which a top portion of the first cup 308 is positioned to secure the first cup 308 to the first lid 314. A set of lid threads 346 are formed in an inner surface of the outer circumferential wall 328 to further facilitate the coupling of the first cup 308 to the first lid 314.

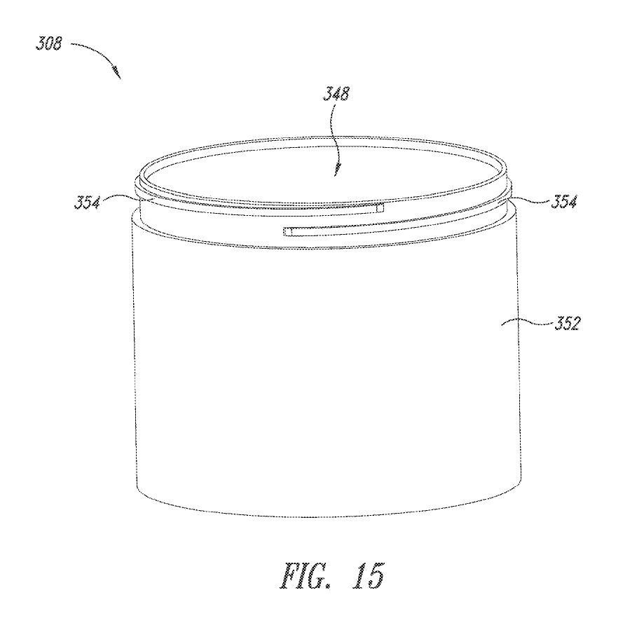

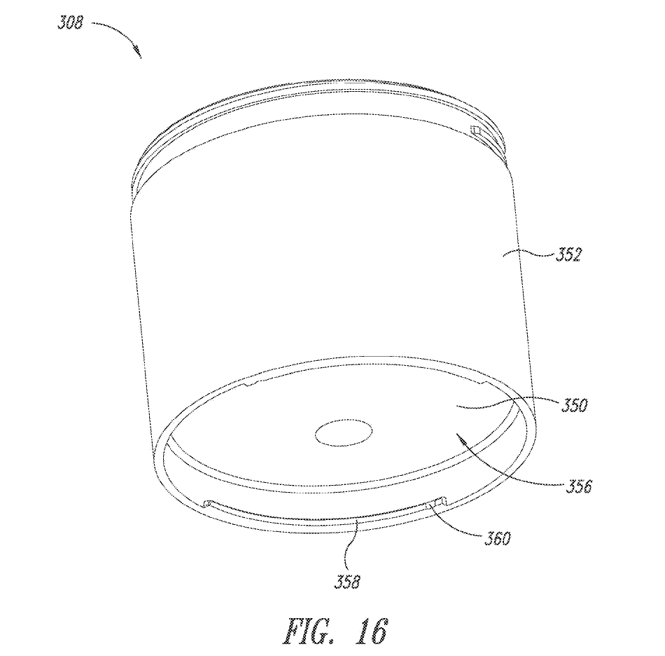

FIGS. 15 and 16 illustrate additional details of the first cup 308, which has a structure matching that of the second cup 310 and the third cup 312. As shown in FIGS. 15 and 16, the first cup 308 includes an open internal space 348 bounded at its bottom by a bottom end wall 350 (FIG. 16) and at its perimeter by a circumferential wall 352. A set of cup threads 354 that is complementary to the lid threads 346 is formed in a top portion of an external surface of the circumferential wall 352. Thus, the top portion of the first cup 308 is positioned within the annular space 344 and the first cup 308 is rotated with respect to the first lid 314 to engage the cup threads 354 with the lid threads 346 to secure or couple the first cup 308 to the first lid 314.

As shown in FIG. 16, the circumferential wall 352 extends longitudinally below the bottom end wall 350 so that the bottom end wall 350 is raised upward from the bottom end of the first cup 308, creating an opening 356 in the bottom end of the first cup 308. A ridge 358 extends partially circumferentially around and radially inward into the opening 356 from an inner surface of a bottom end of the circumferential wall 352. A notch 360 is formed in the ridge 358 near, but spaced apart from, an end of the ridge 358. The ridge 358 has dimensions complementary to the groove 334 and the notch 360 has dimensions complementary to the detent 340 so that these components are engaged with one another to couple the first cup 308 to the first lid 314.

For example, the first lid 314 includes two grooves 334 each extending less than one-quarter of the way around the outer circumferential wall 328 and spaced apart from one another halfway around the outer circumferential wall 328. Similarly, the first cup 308 includes two ridges 358 each extending less than one-quarter of the way around the circumferential wall 352 and spaced apart from one another halfway around the circumferential wall 352. Thus, the first cup 308 is set on top of the first lid 314 and twisted until the ridges 358 engage the grooves 334 and the detents 340 engage the notches 360 to secure or couple the first cup 308 to the first lid 314, without the ridges 358 or grooves 334 being helically threaded.

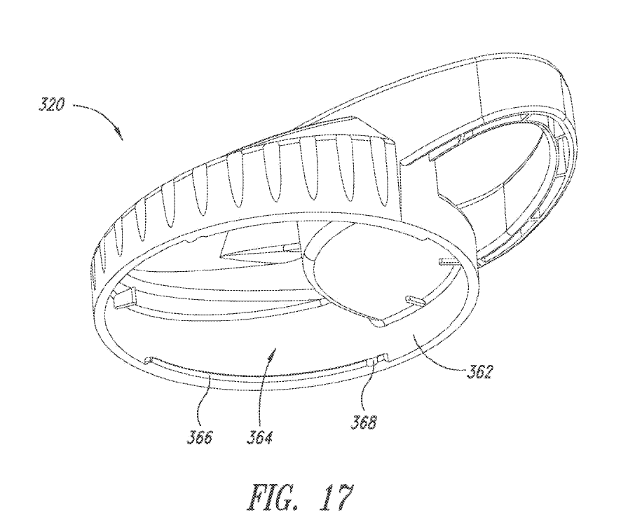

As shown in FIG. 17, the cover 320 includes a circumferential wall 362 that extends longitudinally downward from the rest of the cover 320, creating an opening 364 in the bottom end of the cover 320. A ridge 366 extends partially circumferentially around and radially inward into the opening 364 from an inner surface of a bottom end of the circumferential wall 362. A notch 368 is formed in the ridge 366 near, but spaced apart from, an end of the ridge 366. The cover 320 includes two such ridges 366 having dimensions matching the ridges 358 and two such notches 368 having dimensions matching the notches 360 so that the ridges 366 and notches 368 are engaged with the grooves 334 and detents 340 as described above for the ridges 358 and notches 360 to couple the cover 320 to the first lid 314.

As described above, the first lid 314, second lid 316, and third lid 318 have matching structures and the first cup 308, second cup 310, and third cup 312 have matching structures. Thus, these components are interchangeable with one another in the exploded view of FIG. 12 and any of the first, second, or third lids 314, 316, and 318 are coupleable with either the top end or the bottom end of any of the first, second, or third cups 308, 310, and 312, as is convenient for a user. Similarly, the cover 320 is coupleable with the top end of any one of the first, second, or third lids 314, 316, and 318, as is convenient for the user.

Engagement of a bottom end of the cover 320 or a bottom end of any one of the cups 308, 310, or 312 with a top end of any one of the lids 314, 316, and 318, is achieved using the non-helical quarter-turn ridges 358, 366, and grooves 334, respectively. Engagement of a top end of any one of the cups 308, 310, or 312 with a bottom end of any one of the lids 314, 316, 318, on the other hand, is achieved using the helical and greater than quarter turn threads 354 and 346. Thus, it is quicker and easier to engage and disengage the containers 302, 304, and 306 from one another than it is to engage and disengage the lid and cup of a single one of the containers 302, 304, 306, and a user can more simply interchange and rearrange the containers 302, 304, and 306 without worrying about accidentally opening one of the containers 302, 304, or 306.

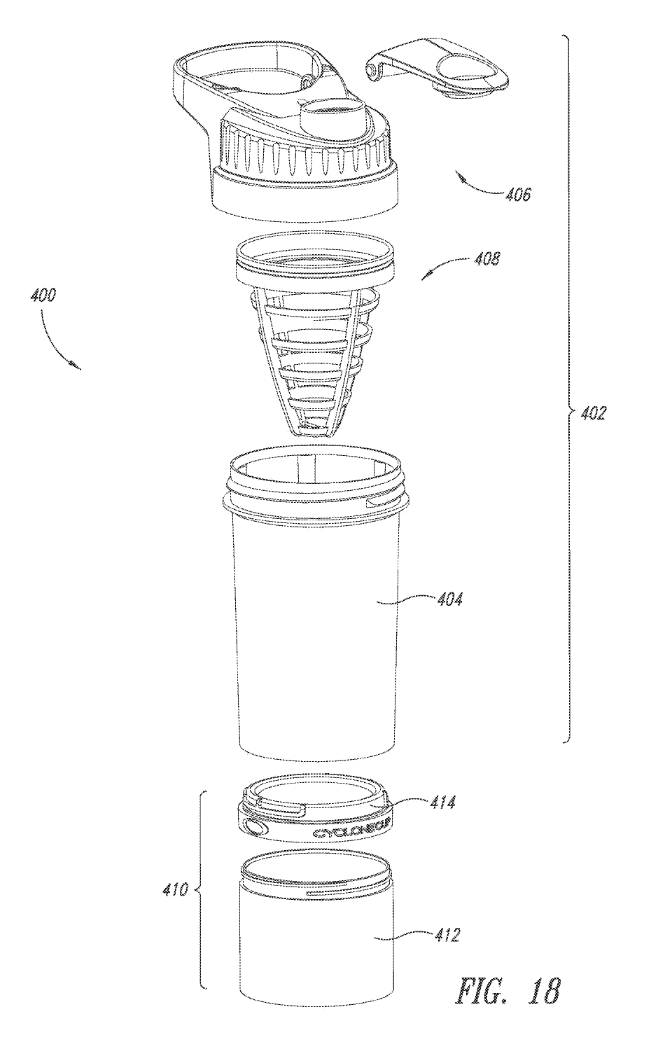

FIG. 18 illustrates an assembly 400 of hand-holdable containers in a disassembled state. The assembly 400 includes a top container 402, which is a mixing cup 402, having a top cup 404 removably coupleable to a top lid 406 and a mixing element 408, and a bottom container 410 having a bottom cup 412 removably coupleable to a bottom lid 414. The assembly 400 of hand-holdable containers has substantial similarities to as well as substantial differences from the assemblies 200 and 300 of hand-holdable containers. Unless stated otherwise herein, or unless physically impossible, the assembly 400 and its respective components will have any of the features described herein for the assemblies 200 and 300 and their respective components, and the assemblies 200 and 300 and their components will have any of the features described herein for the assembly 400 and its components.

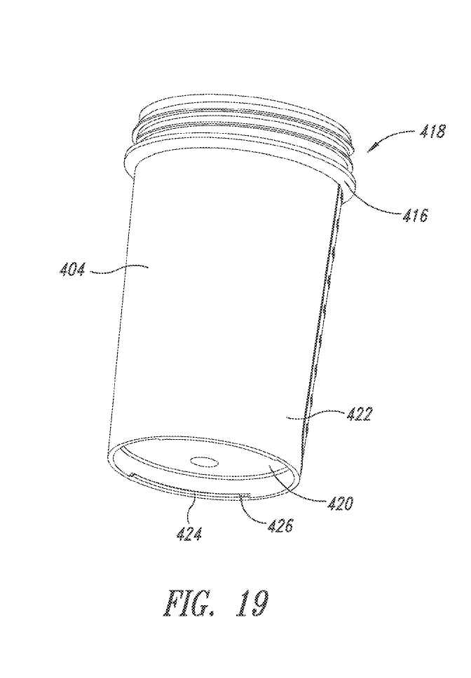

The top lid 406 and the mixing element 408 have structures matching the top lid 206 and the mixing element 208, respectively, and the bottom container 410, bottom cup 412, and bottom lid 414 have structures matching the first container 302, first cup 308, and first lid 314, respectively. As seen in FIG. 19, the top cup 404 includes a top end having a structure matching the top end of the top cup 204, including a ridge 416 matching the ridge 222 and threads 418 matching threads 220. As also seen in FIG. 19, the top cup 404 includes a bottom end having a structure matching the bottom end of the first cup 308, including a bottom end wall 420, a peripheral wall 422, ridges 424, and notches 426 matching the bottom end wall 350, peripheral wall 352, ridges 358, and notches 360, respectively. Thus, the bottom end of the top cup 404 is coupleable to the top end of any one of the first, second, and third lids 314, 316, and 318, as described above for the first, second, and third cups 308, 310, and 312.

In some implementations, the top container 402 is a stand-alone product. In some implementations, the assembly 300 is used as an independent kit of containers. In other implementations, the assembly 400 is used as an independent kit of containers or the assembly 300 and the assembly 400 are used together as an independent kit of containers, e.g., so that a user can select an appropriately sized container or appropriate number of containers to couple to the bottom of the shaker cup 402 from a plurality of differently sized containers. It is to be understood that any combination of the various containers or components described herein can be used together as an independent kit of containers.

The containers described herein are structured to hold any items, whether consumable, such as a food, beverage, or supplement, or non-consumable. As examples, the containers described herein can be used to store and carry liquids such as water, milk, sports drinks, etc., powders such as protein, sports drink, or other flavored powders, or pills. The containers may be sized and shaped to hold any suitable volume(s), such as between 1 oz and 30 oz, with 6, 8, 12, 16, 20, and 24 oz volumes being specific examples. The various implementations described above can be combined to provide further implementations. Aspects of the implementations can be modified, if necessary to employ concepts of the various patents, applications and publications to provide yet further implementations. Further, a designer having ordinary skill in the art will understand that certain aspects of the disclosure as shown in the Figures, such as balance, symmetry, specific curvatures, and relative lengths of components, may be modified for cosmetic purposes without affecting the function and performance of the product. As examples, and without limitation, the specific curvatures of the handles 124 and 216, and of the cover 120 and the top lid 206, the relative height, diameter, and taper of the top cup 204, and the relative heights and tapers of the first, second, and third containers 102, 104, and 106, can be modified for ornamentality without compromising the functional aspects the resulting product.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. An assembly of containers, comprising:
a first container that includes:
a first cup having an interior space defined by at least one wall, a closed bottom end, and an open top;
a first magnetic element positioned in the closed bottom end of the first cup;
a first lid structured to be removably coupled to the first cup and sized and shaped to cover the open top of the first cup, the first lid including a spout; and
a mixing element positioned within the interior space; and
a second container that includes:
a second cup having an interior space defined by at least one wall, a closed bottom end, and an open top;
a second lid configured to be removably coupled to the second cup and sized and shaped to cover the open top of the second cup; and
a second magnetic element complementary to the first magnetic element, the second magnetic element positioned in the second lid and structured to removably couple the second cup to the first cup by magnetic attraction when the second magnetic element is magnetically coupled to the first magnetic element.

2. The assembly of claim 1, wherein the first lid includes:
a through opening structured to be in fluid communication with the interior space of the first cup when the first lid is placed on the first cup;
a cap mounted on the first lid and sized and shaped to move between a closed position in which the cap covers the through opening and prevents liquid from passing through the through opening, and an open position in which fluid is allowed to pass through the through opening;
a third magnetic element mounted on the first lid; and
a fourth magnetic element mounted on the cap and structured to be magnetically attracted to the third magnetic element and hold the cap in the open position by magnetic attraction with the third magnetic element.

3. The assembly of claim 1 wherein each of the first and second lids comprises a top casing and a bottom casing that are removably coupleable to one another to form an enclosed internal space inside each of the first and second lids that is sized and shaped to contain one or more elements to be mixed in the respective first and second cup.

4. The assembly of claim 1 further comprising a cover that includes a base and a handle extending upwardly and laterally away from the base, the base of the cover is sized and shaped to match a size and shape of the first lid to removably couple the cover to the first lid.

5. The assembly of claim 4 wherein the handle comprises a loop of rigid material that can be grasped by a user to hold the assembly, the handle including a passageway and a spring-loaded latch pivotally coupled to the handle to cover the passageway and structured to be manually pushed or otherwise actuated by a user to pivot about a hinge to open and provide access to the passageway in the loop of material of the handle.

6. An assembly of hand-holdable containers, comprising:
a first hand-holdable container that includes:
a first cup having an interior space defined by at least one wall, a closed bottom end, and an open top;
a first magnetic element positioned in the closed bottom end of the first cup;
a first lid structured to be removably coupled to the first cup and sized and shaped to cover the open top of the first cup, the first lid including a spout; and
a mixing element positioned within the interior space; and
a second hand-holdable container that includes:
a second cup having an interior space defined by at least one wall, a closed bottom end, and an open top;
a second lid configured to be removably coupled to the second cup and sized and shaped to cover the open top of the second cup; and
a second magnetic element complementary to the first magnetic element, the second magnetic element positioned in the second lid and structured to removably couple the second cup to the first cup by magnetic attraction when the second magnetic element is magnetically coupled to the first magnetic element.

7. The assembly of claim 6, wherein the first lid includes:
a through opening structured to be in fluid communication with the interior space of the first cup when the first lid is placed on the first cup;
a cap mounted on the first lid and sized and shaped to move between a closed position in which the cap covers the through opening and prevents liquid from passing through the through opening, and an open position in which fluid is allowed to pass through the through opening;
a third magnetic element mounted on the first lid; and
a fourth magnetic element mounted on the cap and structured to be magnetically attracted to the third magnetic element and hold the cap in the open position by magnetic attraction with the third magnetic element.

8. The assembly of claim 6 wherein each of the first and second lids comprises a top casing and a bottom casing that are removably coupleable to one another to form an enclosed internal space inside each of the first and second lids that is sized and shaped to contain one or more elements to be mixed in the respective first and second cup.

9. The assembly of claim 6 further comprising a cover that includes a base and a handle extending upwardly and laterally away from the base, the base of the cover is sized and shaped to match a size and shape of the first lid to removably couple the cover to the first lid.

10. The assembly of claim 9 wherein the handle comprises a loop of rigid material that can be grasped by a user to hold the assembly, the handle including a passageway and a spring-loaded latch pivotally coupled to the handle to cover the passageway and structured to be manually pushed or otherwise actuated by a user to pivot about a hinge to open and provide access to the passageway in the loop of material of the handle.

11. An assembly, comprising:
a shaker cup that includes:
a first cup having an interior space defined by at least one wall, a closed bottom end, and an open top;
a first magnetic element positioned in the closed bottom end of the first cup;
a first lid structured to be removably coupled to the first cup and sized and shaped to cover the open top of the first cup, the first lid including a spout; and
a mixing element positioned within the interior space; and
a container that includes:
a second cup having an interior space defined by at least one wall, a closed bottom end, and an open top;
a second lid configured to be removably coupled to the second cup and sized and shaped to cover the open top of the second cup; and
a second magnetic element complementary to the first magnetic element, the second magnetic element positioned in the second lid and structured to removably couple the second cup to the first cup by magnetic attraction when the second magnetic element is magnetically coupled to the first magnetic element.

12. The assembly of claim 11, wherein the first lid includes:
a through opening structured to be in fluid communication with the interior space of the first cup when the first lid is placed on the first cup;
a cap mounted on the first lid and sized and shaped to move between a closed position in which the cap covers the through opening and prevents liquid from passing through the through opening, and an open position in which fluid is allowed to pass through the through opening;
a third magnetic element mounted on the first lid; and
a fourth magnetic element mounted on the cap and structured to be magnetically attracted to the third magnetic element and hold the cap in the open position by magnetic attraction with the third magnetic element.

13. The assembly of claim 12 wherein each of the first and second lids comprises a top casing and a bottom casing that are removably coupleable to one another to form an enclosed internal space inside each of the first and second lids that is sized and shaped to contain one or more elements to be mixed in the respective first and second cup.

14. The assembly of claim 12 further comprising a cover that includes a base and a handle extending upwardly and laterally away from the base, the base of the cover is sized and shaped to match a size and shape of the first lid to removably couple the cover to the first lid.

15. The assembly of claim 14 wherein the handle comprises a loop of rigid material that can be grasped by a user to hold the assembly, the handle including a passageway and a spring-loaded latch pivotally coupled to the handle to cover the passageway and structured to be manually pushed or otherwise actuated by a user to pivot about a hinge to open and provide access to the passageway in the loop of material of the handle.
